(19) United States
(12) Patent Application Publication
(10) Pub. No.: US 2025/0243634 A1
(43) Pub. Date: Jul. 31, 2025

(54) SYSTEMS AND METHODS FOR LANE MARKING CHANGE DETECTION

(71) Applicant: Toyota Jidosha Kabushiki Kaisha, Toyota-shi (JP)

(72) Inventor: Daniel Pontillo, Rochester, NY (US)

(21) Appl. No.: 18/426,776

(22) Filed: Jan. 30, 2024

(51) Int. Cl. E01C 23/01; G01C 21/00; G06V 20/56; G08G 1/09

(52) U.S. Cl. CPC E01C 23/01; G06V 20/588; G08G 1/09; G01C 21/3815

(57) ABSTRACT

Systems, methods, and other embodiments described herein relate to detecting roadway lane changes by applying a Gaussian mixture model (GMM) to lane marking position data collected by vehicle sensors. In one embodiment, a method includes providing a data set of lane marking positions collected from vehicles traversing a roadway as input to a GMM that represents historic lane marking position data. The method also includes determining a fit of the GMM to a combination of the historic lane marking position data and the data set. The method also includes 1) identifying a change in a lane marking on the roadway based on the fit of the GMM to the combination and 2) generating a notification of the change in the lane marking.

### TECHNICAL FIELD

The subject matter described herein relates, in general, to detecting changes to lane markings on a roadway and, more particularly, to detecting changes to the lane markings by applying a Gaussian mixture model to vehicle-captured indicia of lane marking positions.

### BACKGROUND

Automotive technology is rapidly advancing, with greater autonomy increasingly prevalent in modern vehicles. Autonomous vehicles, which control and/or maneuver a vehicle with little to no input from a human driver, may rely on map data when controlling and/or maneuvering the autonomous vehicle. For example, an autonomous vehicle may navigate a vehicle along a route, which route is defined by map data. Semi-autonomous vehicles, which supplement driver control with some degree of autonomous control, also rely on map data for operation. For example, semi-autonomous vehicles may limit the lateral movement of a vehicle upon a determination that the vehicle is about to exit a particular road lane. Manually operated vehicles may also rely on map data during operation. For example, lane-specific navigation instructions may be provided to a human driver through a human-machine interface.

However, over time, map data may become outdated as changes to the roadway are made, but no corresponding updates to the map data are made. Accordingly, the greater the accuracy of the map data upon which manually-operated, semi-autonomous, and autonomous vehicles rely, the better a driver can be supplemented with information to assist in driving and/or the better an autonomous system can control the vehicle.

### SUMMARY

In one embodiment, example systems and methods relate to a manner of improving the detection of changes to lanes in a roadway.

In one embodiment, a lane marking change detection system for applying a Gaussian mixture model to lane marking position data collected by vehicle sensors is disclosed. The lane marking change detection system includes one or more processors and a memory communicably coupled to the one or more processors. The memory stores instructions that, when executed by the one or more processors, cause the one or more processors to provide a data set of lane marking positions collected from vehicles traversing a roadway as input to a Gaussian mixture model (GMM) that represents historic lane marking position data. The memory also stores instructions that, when executed by the one or more processors, cause the one or more processors to determine a fit of the GMM to a combination of the historic lane marking position data and the data set. The memory stores instructions that, when executed by the one or more processors, cause the one or more processors to 1) identify a change in a lane marking on the roadway based on the fit of the GMM to the combination and 2) generate a notification of the change in the lane marking.

In one embodiment, a non-transitory computer-readable medium for applying a GMM to lane marking position data collected by vehicle sensors and including instructions that, when executed by one or more processors, cause the one or more processors to perform one or more functions is disclosed. The instructions include instructions to provide a data set of lane marking positions collected from vehicles traversing a roadway as input to a GMM that represents historic lane marking position data. The instructions also include instructions to determine a fit of the GMM to a combination of the historic lane marking position data and the data set. The instructions also include instructions to 1) identify a change in a lane marking on the roadway based on the fit of the GMM to the combination and 2) generate a notification of the change in the lane marking.

In one embodiment, a method for applying a GMM to lane marking position data collected by vehicle sensors is disclosed. In one embodiment, the method includes providing a data set of lane marking positions collected from vehicles traversing a roadway as input to a GMM that represents historic lane marking position data. The method also includes determining a fit of the GMM to a combination of the historic lane marking position data and the data set. The method also includes 1) identifying a change in a lane marking on the roadway based on the fit of the GMM to the combination and 2) generating a notification of the change in the lane marking.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of applying a Gaussian mixture model to lane marking position data from sensor systems of multiple vehicles.

FIG. 2 illustrates one embodiment of a lane marking change detection system that is associated with detecting lane marking changes via onboard vehicle sensors.

FIG. 3 illustrates one embodiment of the lane marking change detection system of FIG. 2 in a remote computing device.

FIG. 4 illustrates a flowchart for one embodiment of a method that is associated with detecting lane marking changes via onboard vehicle sensors.

FIG. 5 illustrates the detection of a lane shift from lane marking position data.

FIG. 6 illustrates the detection of an added lane from lane marking position data.

FIG. 7 illustrates the detection of a removed lane from lane marking position data.

### DETAILED DESCRIPTION

Systems, methods, and other embodiments associated with improving roadway lane marking change detection are disclosed herein. As previously described, accurate map data increases the safety and reliability of vehicle operation, whether the vehicle is manually operated, semi-autonomous, or fully autonomous. As a specific example, if the position of lanes is inaccurately identified in map data, a control system may position an autonomous vehicle in a location that is believed to be between lane lines but may be crossing lane lines. In other words, inaccurate lane markings may lead to the imprecise and incorrect lateral positioning of a vehicle on the roadway. Moreover, any lane-specific navigation instructions provided to a manually operated vehicle may be erroneous if, for example, a lane has been removed or added to a roadway. As such, map data that inaccurately represents the lanes of a roadway may generate confusion and unnecessary risk to motorists and other road users. While particular reference is made to particular complications that may arise when map data is inaccurate, a variety of other potentially dangerous situations may arise when map data does not accurately reflect the position of lane markings on the roadway surface.

Map data inaccuracies may arise in several situations. For example, lane markings on a roadway may be adjusted over time. As specific examples, lane marking positions may be shifted, additional lane markings may be added, and/or lane markings may be removed from a roadway. As yet another example, lane markings may fade over time or may otherwise become unobservable by a motorist and may cause confusion and/or danger as a motorist tries to navigate the roadway without knowing the precise location of lane markings.

For these and other reasons, the lane marking change detection system of the present specification improves the timeliness of identifying roadway lane marking changes and enhances the accuracy and reliability of map data upon which various vehicle systems, whether autonomous or not, rely to facilitate safe navigation of roads. Specifically, the lane marking change detection system identifies lane marking changes based on lane marking position data collected from vehicles. Specifically, vehicles may have onboard sensor systems that identify lane markings on roads and can communicate the position of such to the lane marking change detection system. However, detected lane markings from multiple vehicles may be imprecise for various reasons. For example, different vehicles may have sensors with different orientations relative to the road surface. Moreover, there may be inaccuracies in the measurement systems and sensor data collected by vehicles, as well as the processing of such sensor data to determine the position of the lane markings. Moreover, different environmental conditions, such as poor lighting, faded paint, etc., also introduce errors and/or inaccuracies to the determination of a lane marking position.

Accordingly, the lane marking change detection system of the present specification applies a Gaussian mixture model (GMM) to historically collected lane position data from various vehicles. A Gaussian mixture model is a probabilistic model that identifies normally-distributed subsets of data within an overall set of data, In an example, the overall set of data includes individual lane marking measurements and the different subsets correspond to the individual lane marking positions on the roadway surface. That is, the GMM identifies a probabilistic position of the lane markings on the roadway surface. The output of the GMM is a Gaussian curve for each expected cluster of objects, which in the present case is a probabilistic location of a lane marking on the roadway surface.

As new data is collected in real-time, the lane marking change detection system adds the newly collected data to the GMM and evaluates the fit of the GMM to the combination of the historical data and the currently collected data. If the fit metric indicates that the GMM is a poorer fit of the overall data set with the currently collected data added, the lane marking change detection system may infer that there has been a change to the lane structure of the roadway. As a specific example, if the historically-collected data is collected when a roadway had three lanes, a GMM that identifies four clusters (i.e., four lane lines) may have a relatively satisfactory fit. However, if the lane structure of the roadway is altered to have four lanes or two lanes, the three-lane GMM may no longer fit the data. That is, the fitness of the GMM to the data, with the currently collected data included, may indicate whether there has been a change to the lane structure of a roadway segment. In an example, the GMM may be a supervised model trained on the ground truth of an expected number of lanes for a roadway. In another example, the GMM is unsupervised, where the GMM itself determines the number of lanes for a roadway. In an example, the GMM may be fit to various data sequences. That is, the currently collected data, which may trigger an indication of a lane change, may be batched data collected over multiple days. In this way, the disclosed systems, methods, and other embodiments improve map data accuracy, lane marking detection, vehicle autonomous control, and/or navigation accuracy, reliability, and safety.

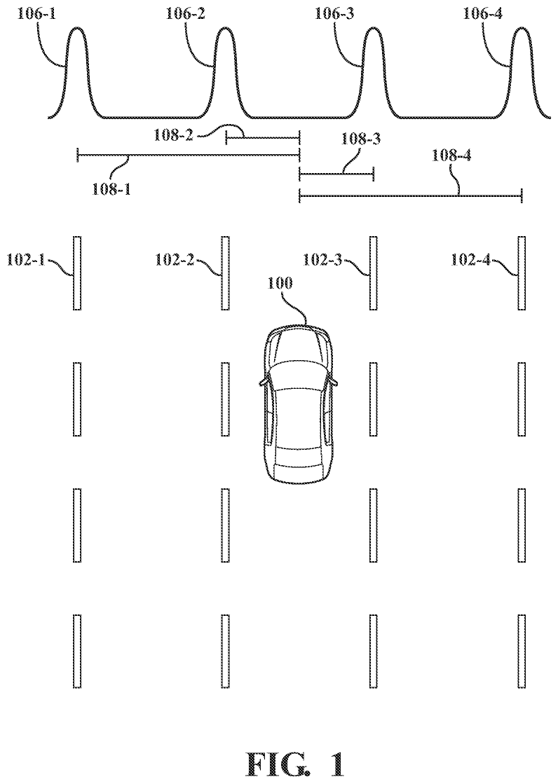

Turning now to the figures, FIG. 1 will now be discussed in full detail as an example environment within which the system and methods disclosed herein may operate. It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

Specifically, FIG. 1 illustrates one embodiment of applying a GMM to lane marking position data from multiple vehicles 100. As used herein, a “vehicle” is any form of transport that may be motorized or otherwise powered. In one or more implementations, the vehicle 100 is an automobile. While arrangements will be described herein with respect to automobiles, it will be understood that embodiments are not limited to automobiles. In some implementations, the vehicle 100 may be a robotic device or a form of transport that, for example, includes sensors to perceive aspects of the surrounding environment, and thus benefits from the functionality discussed herein associated with lane markings on a surface.

In some instances, the vehicle 100 is configured to switch selectively between an autonomous mode, one or more semi-autonomous modes, and/or a manual mode. “Manual mode” means that all of or a majority of the control and/or maneuvering of the vehicle is performed according to inputs received via manual human-machine interfaces (HMIs) (e.g., steering wheel, accelerator pedal, brake pedal, etc.) of the vehicle 100 as manipulated by a user (e.g., human driver). In one or more arrangements, the vehicle 100 can be a manually-controlled vehicle that is configured to operate in only the manual mode.

In one or more arrangements, the vehicle 100 implements some level of automation in order to operate autonomously or semi-autonomously. As used herein, automated control of the vehicle 100 is defined along a spectrum according to the SAE J3016 standard. The SAE J3016 standard defines six levels of automation from level zero to five. In general, as described herein, semi-autonomous mode refers to levels zero to two, while autonomous mode refers to levels three to five. Thus, the autonomous mode generally involves control and/or maneuvering of the vehicle 100 along a travel route via a computing system to control the vehicle 100 with minimal or no input from a human driver. By contrast, the semi-autonomous mode, which may also be referred to as advanced driving assistance system (ADAS), provides a portion of the control and/or maneuvering of the vehicle via a computing system along a travel route with a vehicle operator (i.e., driver) providing at least a portion of the control and/or maneuvering of the vehicle 100.

An automated driving module of the vehicle 100 either independently or in combination with the lane marking change detection system of the present specification can be configured to determine travel path(s), current autonomous driving maneuvers for the vehicle 100, future autonomous driving maneuvers, and/or modifications to current autonomous driving maneuvers based on data acquired by the sensor system of the vehicle and/or another source. In general, the automated driving module(s) of the vehicle 100 functions to, for example, implement different levels of automation, including advanced driving assistance (ADAS) functions, semi-autonomous functions, and fully autonomous functions, as previously described.

As described above, the vehicle 100 includes a sensor system that includes sensors such as a camera, LiDAR sensor, radar sensor, and other sensors that detect the environment surrounding the vehicle 100. In one particular example, the sensor system detects lane markings 102-1, 102-2, 102-3, and 102-4 on the roadway surface. For simplicity in illustration, a few instances of lane markings 102-1, 102-2, 102-3, and 102-4 are indicated with reference numbers in FIG. 1. The vehicle 100 itself, or the lane marking change detection system, identifies a position of the lane marking 102. In one example, the lane marking position may be a relative lateral position 108 from the center of the road. That is, the lane marking change detection system may treat the center of the road as a reference point from which any lateral offset can be measured.

Via image analysis of a vehicle camera or other analysis of an environment sensor of the vehicle 100, a processor may determine the lateral position 108 of the different lane markings 102 of the road. For example, a first lane marking 102-1 may be identified as having a lateral position 108-1 of −12.5 feet, indicating that the first lane marking 102-1 is twelve and a half feet to the left of the center of the road. Similarly, a second lane marking 102-2 may be identified as having a lateral position 108-2 of −2.5 feet, indicating that the second lane marking 102-2 is two and a half feet to the left of the center of the road. A third lane marking 102-3 may be identified as having a lateral position 108-3 of +2.5 feet, indicating that the third lane marking 102-3 is two and a half feet to the right of the center of the road. Similarly, a fourth lane marking 102-4 may be identified as having a lateral position 108-4 of +12.5 feet, indicating that the third lane marking 102-3 is twelve and a half feet to the right of the center of the road. While particular lateral positions and notations are described herein, different formats for indicating the lane marking 102 positions may be relied on. In any case, the sensor system of the vehicle 100 detects the lane markings, and the vehicle 100 or the lane marking change detection system, determines the lateral position of the detected lane markings.

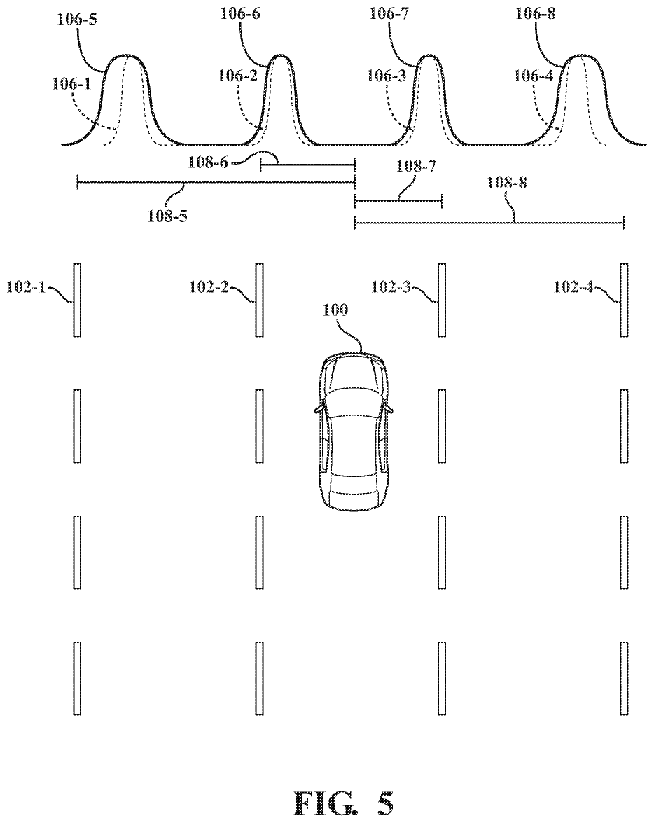

As described above, the lateral position measurements may be imprecise for various reasons, including limitations on sensor system accuracy, variation between different vehicle sensor systems, and environmental conditions. For example, in low-light conditions, an edge-based detection system may have more difficulty ascertaining the precise boundary of the lane markings 102. For these and other reasons, the system combines measurements from different vehicles 100 and indicates a probabilistic location of the lane markings 102. Specifically, as described above, the lane marking change detection system applies a GMM, which is a probabilistic model, to the data set of lane marking 102 position measurements. Rather than outputting the exact location of the lane markings 102, the probabilistic model generates probability curves, or Gaussian curves, which indicate the likely position of the lane markings 102. As depicted in FIG. 1, the output of the GMM is various Gaussian curves 106-1, 106-2, 106-3, and 106-4, each of which pertains to a likely lane marking 102 location. A Gaussian curve 106 is defined by its mean and variance. The steeper the sides of the Gaussian curve 106, the better the fit of the model to the data. Note that the Gaussian curves 106 depicted in the figures, and the changes to the Gaussian curves depicted in FIGS. 5-7 may represent the combination of various measurements from various vehicles.

As described above, the lane structure of a road may change, or the lane markings 102 may fade making them difficult for sensor observation. Accordingly, the lane marking change detection system detects changes in the lanes of a roadway over time. The lane marking change detection system identifies changes based on 1) changes to the fitness of a GMM to data as currently collected data is added and 2) changes to the shape of the Gaussian curves as currently collected data is added. That is, as the lane markings 102 shift, as depicted in FIGS. 5-7, the newly collected data alters the shape of the Gaussian curves, thus reducing the “fit” of the model to the data (i.e., the lane position marking data). If the reduced fit falls below a threshold or changes by a threshold amount, the lane marking change detection system determines that there has been a change to the lane structure of the roadway. Accordingly, an initial GMM is applied to historically collected data indicative of lane marking position, with the output being the Gaussian curves 106-1, 106-2, 106-3, and 106-4. The change in the model fit is monitored as currently collected data is fed to the GMM that is trained on the historically collected data indicative of lane marking position. When the GMM begins to fail (e.g., the fit quality falls below a threshold amount or is reduced by a threshold amount), the lane marking change detection system infers that there has been some change to the lane structure of the roadway (e.g., lanes have shifted position, lanes have been added, lanes have been removed) or lane markings have become obscured (e.g., faded) such that any map data that represents the roadway is similarly, likely inaccurate. As such, the present system identifies lane marking changes based on changes to the fitness of a GMM to the underlying lane position marking data.

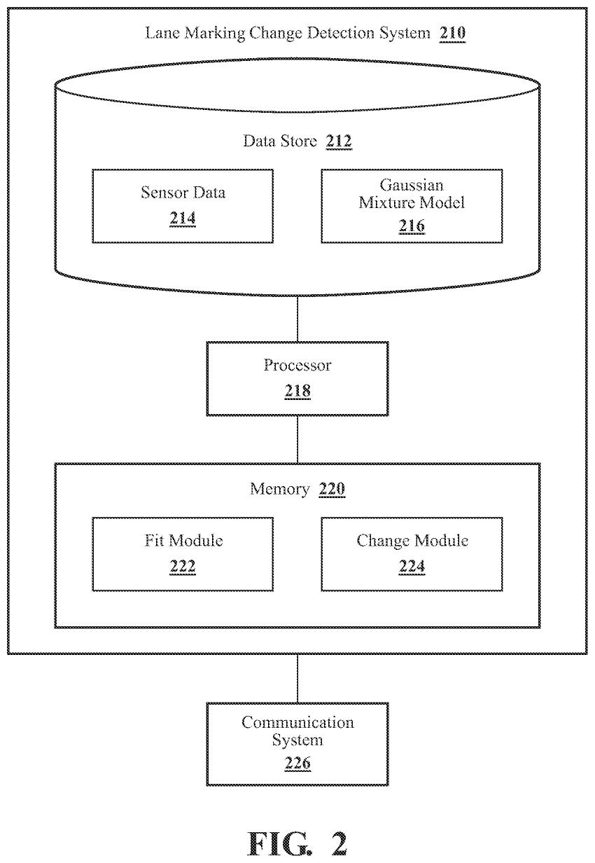

FIG. 2 illustrates one embodiment of a lane marking change detection system 210 that is associated with detecting lane marking changes via onboard vehicle sensors. The lane marking change detection system 210 includes one or more processors 218. In one or more arrangements, the processor(s) 218 may be a primary/centralized processor or may be representative of many distributed processing units. For instance, the processor(s) 218 can be an electronic control unit (ECU). Alternatively, or additionally, the processors include a central processing unit (CPU), a graphics processing unit (GPU), an application-specific integrated circuit (ASIC), a microcontroller, a system on a chip (SoC), and/or other electronic processing units that support the operation of the lane marking change detection system 210.

The lane marking change detection system 210 can include one or more data stores 212 for storing one or more types of data. The data store 212 is, in one embodiment, an electronic data structure stored in the memory 220 or another data storage device and that is configured with routines that can be executed by the processor 218 for analyzing stored data, providing stored data, organizing stored data, and so on. Thus, in one embodiment, the data store 212 stores data used by the modules 222 and 224 in executing various functions. The data store 212 can be comprised of volatile and/or non-volatile memory. Examples of memory that may form the data store 212 include Random Access Memory (RAM), flash memory, Read Only Memory (ROM), Programmable Read-Only Memory (PROM), Erasable Programmable Read-Only Memory (EPROM), Electrically Erasable Programmable Read-Only Memory (EEPROM), registers, magnetic disks, optical disks, hard drives, solid-state drivers (SSDs), and/or other non-transitory electronic storage medium. In one configuration, the data store 212 is a component of the processor(s) 218. In general, the data store 212 is operatively connected to the processor(s) 218 for use thereby. The term “operatively connected,” as used throughout this description, can include direct or indirect connections, including connections without direct physical contact.

As described above, the lane marking change detection system 210 identifies changes to the lane structure of a roadway based at least in part on sensor data collected by various vehicles 100 as they traverse the roadway. As such, the sensor data 214 includes at least that data collected by the sensors of the vehicle 100 that perceive the lane markings 102.

The sensor data 214 may take a variety of forms. For example, the sensor data 214 may be images captured by a camera on the vehicle 100. That is, a vehicle 100 may include a camera that faces outward to capture images of objects in the environment such as pedestrians, other vehicles, and in the case of the present specification, lane markings 102 on the road surface. While particular reference is made to camera images, the sensor data 214 may include other types of data, such as LiDAR sensor output, radar sensor output, sonar sensor output, or any other type of output that captures or perceives the lane markings 102 on a roadway.

In an example, the sensor data 214 itself includes the lane marking position data. For example, the sensor data 214 may include the geographic coordinates of an object, which coordinates an onboard sensor of the vehicle 100 infers from the camera or other sensor output. In another example, the sensor data 214 includes the camera or other sensor output, and a lane marking change detection system 210 component infers the lane marking position data.

The sensor data 214 may include information collected from multiple vehicles over time. That is, as described above and in greater detail below, the GMM 216 fits historically-collected lane marking position data. As such, the sensor data 214 includes historically-collected sensor output from multiple vehicles and, in some cases, the lane marking position data inferred by multiple vehicle processors.

In one embodiment, the data store 212 stores the sensor data 214 along with, for example, metadata that characterizes various aspects of the sensor data 214. For example, the metadata can include location coordinates (e.g., longitude and latitude), relative map coordinates or tile identifiers, time/date stamps from when the separate sensor data 214 was generated, and so on.

In one embodiment, the data store 212 further includes the Gaussian mixture model 216. As described above, the GMM 216 is a probabilistic model that groups a population of data into categories, or clusters, based on the similarity of the underlying data. The GMM 216 may operate under the assumption that all data points are generated from a mixture of a finite number of groups, each with unknown parameters (e.g., mean and variance). In the context of the present specification, the GMM 216 clusters data points (i.e., lane marking position data) into clusters to indicate the probable location of various detected lane markings. That is, the GMM 216 groups data points together that belong to a single lane marking position. As described above, due to variations in measurement systems (e.g., cameras, sensors, processing resources) and environmental conditions, it may be challenging to determine the exact location of a road lane marking 102. As such, a GMM 216 approximates or generates a statistical inference of the location of the lane markings 102. An example of the GMM 216 is provided below.

$$p ( \vec{x} ) = {\sum }_{i = 1}^{K} {∅}_{i} N ( \vec{x} \vert \vec{{μ}_{l}} , {Σ}_{i} )$$

$$N ( \vec{x} \vert \vec{{μ}_{l}} {Σ}_{i} ) = \frac{1}{\sqrt{{( 2 π )}^{K} \vert {Σ}_{i} \vert}} exp ( - \frac{1}{2} {( \vec{x} - \vec{{μ}_{ι}} )}^{T} {Σ}_{i}^{- 1} ( \vec{x} - \vec{{μ}_{ι}} ) )$$

$${\sum }_{i = 1}^{K} {∅}_{i} = 1$$

The output of a GMM 216 are Gaussian curves 106 with peaks defined by a mean value (i.e., the average of the lane marking position measurements for a given cluster and a lateral position that the system predicts as the most likely location for a lane marking 102) and a variance, spread or width of the data, which variance, spread or width indicates the noise/variation in the measurements. The GMM 216 outputs a probability that a particular lane marking measurement is associated with a particular lane marking 102 on a roadway surface. Put another way, the GMM 216 may output a statistical inference that a particular lane marking measurement pertains to a particular lane marking 102 on a roadway surface.

In an example, during training the input to the GMM 216 is the data points representing the historically-calculated lane marking position data, collected over time as multiple vehicles 100 pass along the roadway. In one example, the GMM 216 is a supervised model where, in addition to the lane marking position data points, the GMM 216 is also provided with the number of lanes for the roadway. That is, the GMM 216 is provided with an initial state or ground truth, and the GMM 216 clusters the historically-collected lane marking position data points into a proportional number of clusters. For example, if the ground truth input is that a road segment has three lanes, the GMM 216 will generate four clusters (as four lane markings define three lanes) and assign each measurement to one of the four clusters. In this example, the lane marking change detection system 210 identifies changes that happen in the future at some point in time after the initial state or ground truth is established. In this example, the initial state or ground truth may be fed to the GMM 216 from an operator or mined from curated map data associated with the road network that indicates the number of lane markings for a given road segment.

In another example, the GMM 216 may be unsupervised. In an example, an unsupervised GMM 216 may be referred to as a Bayesian Gaussian mixture model. In this example, the GMM 216 is not fed with a ground truth of the number of lanes of a road segment. Instead, the GMM 216 considers the population of data points and infers the number of clusters or Gaussian curves and their respective distributions based on an analysis of the population of data points.

In one embodiment, the lane marking change detection system 210 includes a memory 220 that stores a fit module 222 and a change module 224. The memory 220 is a random-access memory (RAM), read-only memory (ROM), a hard-disk drive, a flash memory, or another suitable memory for storing the modules 222 and 224. In at least one arrangement, the modules 222 and 224 are implemented as non-transitory computer-readable instructions that, when executed by the processor 218, implement one or more of the various functions described herein. In various arrangements, one or more of the modules 222 and 224 are a component of the processor(s) 218, or one or more of the modules 222 and 224 are executed on and/or distributed among other processing systems to which the processor(s) 218 is operatively connected. Alternatively, or in addition, the one or more modules 222 and 224 are implemented, at least partially, within hardware. For example, the one or more modules 222 and 224 may be comprised of a combination of logic gates (e.g., metal-oxide-semiconductor field-effect transistors (MOSFETs)) arranged to achieve the described functions, an ASIC, programmable logic array (PLA), field-programmable gate array (FPGA), and/or another electronic hardware-based implementation to implement the described functions. Further, in one or more arrangements, one or more of the modules 222 and 224 can be distributed among a plurality of the modules described herein. In one or more arrangements, two or more of the modules 222 and 224 described herein can be combined into a single module.

The lane marking change detection system 210 includes a fit module 222 that, in one embodiment, includes instructions that cause the processor 218 to 1) provide a data set of lane marking positions collected from vehicles 100 traversing a roadway as input to a GMM 216 that represents historic lane marking position data and 2) determine a fit of the GMM 216 to a combination of the historic lane marking position data and the data set. That is, as described above, a GMM 216 may be trained on historically-collected lane marking position data. Based on the historically-collected lane marking position data, the GMM 216 outputs a number of peaks/clusters, a mean value for each cluster, and a variance value for each cluster. In one particular example, the fit module 222 can undertake various approaches to fuse data from multiple sensors when providing the sensor data 214 and/or from sensor data acquired over a wireless communication link (e.g., v2v) from one or more of the surrounding vehicles 100. Thus, the sensor data 214, in one embodiment, represents a combination of perceptions acquired from multiple sensors.

In an example, the GMM 216 generates initial Gaussian curves 106 based on the historically-collected lane marking position data. During a collection period, or after the initial Gaussian curves 106 are generated, vehicles 100 continue to collect lane marking position data, or data from which the lane marking position data may be determined. This additional data is also fed to the GMM 216, which additional data may alter the Gaussian curves 106. For example, if the currently collected data differs from the historically collected lane marking position data, the variance and/or mean of the Gaussian curves 106 may shift. This difference in Gaussian distributions allows the lane marking change detection system 210 to determine any change to the lane structure of a roadway.

In addition to facilitating the generation of the Gaussian curves 106, the fit module 222 evaluates the fit of the GMM 216 to the sensor data 214. That is, the fitness of the GMM 216 defines the accuracy with which the model represents the underlying data. In the context of the present specification, a GMM 216 may have a good “fit” for the lane marking position data if it accurately reflects the location of the lane markings 102 on the roadway. There are a variety of operations to determine whether the GMM 216 fits the underlying data. One example is the Bayesian Information Criterion (BIC), which may be represented by the following equation.

$$BIC = k ln ( n ) - 2 ln ( \hat{L )}$$

Where \hat{L} is the maximum value of the likelihood function of the model, n is the number of data points, and k is the number of free parameters to be estimated. In general, a lower BIC indicates a better fit quality. As such, when the underlying data changes (i.e., currently-collected lane marking position data is added), the BIC value for the GMM 216 may rise if the currently-collected data differs from the historically-collected data.

Another example of a GMM fit metric is the Silhouette score, which measures mean silhouette coefficients across all samples at a given fit step. The silhouette coefficient is calculated using the following equation.

$$SC = \frac{( b - a )}{max ( a , b )}$$

Where a is the mean intra-cluster distance and b is the mean nearest-cluster distance for each sample. While particular reference is made to particular fitness metrics, the fit module 222 may implement various fitness metrics to evaluate the GMM 216 both before and after currently collected data is provided to the GMM 216 as input.

It should be appreciated that the fit module 222, in combination with the GMM 216, can form a computational model such as a neural network model. In any case, the fit module 222, when implemented with a neural network model or another model, in one embodiment, implements functional aspects of the model GMM 216 while further aspects, such as learned weights, may be stored within the data store 212. Accordingly, the GMM 216 is generally integrated with the fit module 222 as a cohesive functional structure.

In one approach, the fit module 222 implements and/or otherwise uses a machine learning algorithm. In one configuration, the machine learning algorithm is embedded within the fit module 222, such as a convolutional neural network (CNN), to perform lane marking position identification and model fitting over the sensor data 214 from which further information is derived. Of course, in further aspects, the fit module 222 may employ different machine learning algorithms or implement different approaches for performing the lane marking position identification which can include deep convolutional encoder-decoder architectures, a multi-scale context aggregation approach using dilated convolutions, or another suitable approach that generates Gaussian curves 106 and associated fits. Whichever particular approach the fit module 222 implements, the fit module 222 provides an output with lane marking positions represented in the sensor data 214. In this way, the fit module 222 evaluates what affect the currently-collected data has on the GMM 216.

In one or more configurations, the lane marking change detection system 210 implements one or more machine learning algorithms. As described herein, a machine learning algorithm includes but is not limited to deep neural networks (DNN), including transformer networks, convolutional neural networks, recurrent neural networks (RNN), etc., Support Vector Machines (SVM), clustering algorithms, Hidden Markov Models, and so on. It should be appreciated that the separate forms of machine learning algorithms may have distinct applications, such as agent modeling, machine perception, and so on.

Moreover, it should be appreciated that machine learning algorithms are generally trained to perform a defined task. Thus, the training of the machine learning algorithm is understood to be distinct from the general use of the machine learning algorithm unless otherwise stated. That is, the lane marking change detection system 210 or another system generally trains the machine learning algorithm according to a particular training approach, which may include supervised training, self-supervised training, reinforcement learning, and so on. In contrast to training/learning of the machine learning algorithm, the lane marking change detection system 210 implements the machine learning algorithm to perform inference. Thus, the general use of the machine learning algorithm is described as inference.

The lane marking change detection system 210 also includes a change module 224 that, in one embodiment, includes instructions that cause the processor 218 to 1) identify a change in a lane marking 102 on the roadway based on the fit of the GMM 216 to the combination of the historic lane marking position data and the currently-collected data set and 2) generate a notification of the change to the lane marking. That is, the change module 224 is operatively connected to the fit module 222 to receive the output of the fit module 222 i.e., the Gaussian curves 106 and the fitness metric for the GMM 216 to the data both before and after the inclusion of the currently-collected data. Specifically, a lower fit, or a lower quality fit of the GMM 216 to the underlying data suggests a change to the lane structure of the roadway. As such, the change module 224 processes the fit data to determine whether or not there has been a change to the lane structure of the road. For example, the GMM 216 may have a first BIC value relative to the historically-collected lane marking position data. Following the addition of the currently collected lane marking position data, the GMM 216 may have a second BIC value, which is greater than the first BIC value. This increase in BIC value, and reduction in the fit, may indicate a change in the road structure.

In one example, the change module 224 determines there has been a change to the lane structure based on the measured fitness metric of the GMM 216 to the combination of the historically-collected and currently-collected data. In other words, the change may be detected when the fit of the GMM 216 to the combination is lower than a threshold amount.

In another example, the change module 224 determines there has been a change to the lane structure based on the change to the fitness metric responsive to the addition of the currently collected data. That is, in this latter example the identification of a lane change is not based on the absolute/measured fit metric of the GMM 216 but is based on the change to the fitness metric of the GMM 216 with the currently-collected data added. In either example, the thresholds to which the absolute fitness metric or the fitness metric change are compared may be selected by an operator based on any criteria.

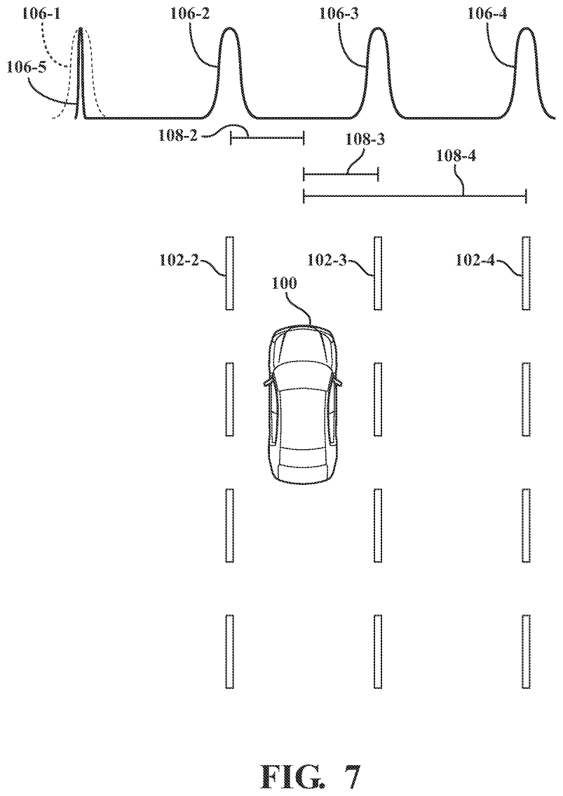

In addition to detecting that a lane marking change has occurred, the change module 224 may detect a type of lane marking change that has occurred. As described above, adding currently collected data to the data set upon which the GMM 216 operates may alter the Gaussian distribution/curves that are output. By analyzing these Gaussian distributions, the change module 224 can determine what change has been made to the lane structure. As one specific example, one Gaussian curve 106 that is narrower than others may indicate that a lane has been removed, as depicted in FIG. 7.

In either case, the change module 224 generates a notification of the change. In one particular example, the notification may be provided to a map manager. A map manager refers to an individual or organization that curates, operates, and manages map data that is ultimately provided to vehicles 100 to facilitate navigation and/or autonomous control of the vehicles 100.

The lane marking change detection system 210, as provided for within the vehicle 100, functions in cooperation with a communication system 226. Via the communication system 226, the lane marking change detection system 210 collects sensor data from the vehicles 100 that traverse a roadway.

In one embodiment, the communication system 226 communicates according to one or more communication standards. For example, the communication system 226 can include multiple different antennas/transceivers and/or other hardware elements for communicating at different frequencies and according to respective protocols. The communication system 226, in one arrangement, communicates via a communication protocol, such as a WiFi, dedicated short-range communication (DSRC), vehicle-to-infrastructure (V2I), vehicle-to-vehicle (V2V), or another suitable protocol. Moreover, the communication system 226, in one arrangement, further communicates according to a protocol, such as global system for mobile communication (GSM), Enhanced Data Rates for GSM Evolution (EDGE), Long-Term Evolution (LTE), 5G, or another communication technology that provides for the lane marking change detection system 210 communicating with various remote devices (e.g., a cloud-based server). In any case, the lane marking change detection system 210 can leverage various wireless communication technologies to provide communications to other entities, such as members of the cloud-computing environment.

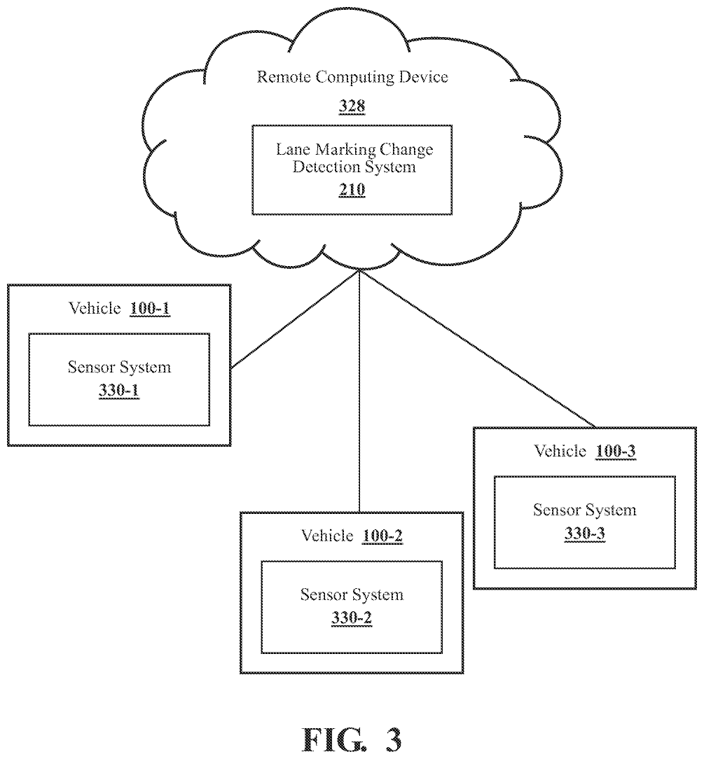

FIG. 3 illustrates one embodiment of the lane marking change detection system 210 of FIG. 2 in a remote computing device 328. In an example, the lane marking change detection system 210 is located at a remote computing device 328. In this example, the lane marking change detection system 210 is connected to various vehicles 100 via the communication system 226 and the individual vehicle 100 communication systems. For example, the lane marking change detection system 210 may acquire sensor data 214 from the sensor systems 330-1, 330-2, and 330-3 of various vehicles 100-1, 100-2, and 100-3 and detect changes to the lane structure of a roadway based on such.

As described above, each vehicle 100 can include a sensor system 330. The sensor system 330 can include one or more sensors. As described herein, “sensor” means an electronic and/or mechanical device that generates an output (e.g., an electric signal) responsive to a physical phenomenon, such as electromagnetic radiation (EMR), sound, etc. The sensor system 330 and/or the one or more sensors can be operatively connected to a processor(s), data store(s), and/or another element of the vehicle 100.

Various examples of different types of sensors will be described herein. However, it will be understood that the embodiments are not limited to the particular sensors described. In various configurations, the sensor system 330 includes one or more vehicle sensors and/or one or more environment sensors. The vehicle sensor(s) function to sense information about the vehicle 100 itself. In one or more arrangements, the vehicle sensor(s) include one or more accelerometers, one or more gyroscopes, an inertial measurement unit (IMU), a dead-reckoning system, a global navigation satellite system (GNSS), a global positioning system (GPS), and/or other sensors for monitoring aspects about the vehicle 100.

As noted, the sensor system 330 can include one or more environment sensors that sense a surrounding environment (e.g., external) of the vehicle 100 and/or, in at least one arrangement, an environment of a passenger cabin of the vehicle 100. For example, the one or more environment sensors sense objects in the surrounding environment of the vehicle 100. Such obstacles may be stationary objects such as lane markings 102 and/or dynamic objects. Various examples of sensors of the sensor system 330 will be described herein. The example sensors may be part of the one or more environment sensors and/or the one or more vehicle sensors. However, it will be understood that the embodiments are not limited to the particular sensors described. As an example, in one or more arrangements, the sensor system 330 includes one or more radar sensors, one or more LiDAR sensors, one or more sonar sensors (e.g., ultrasonic sensors), and/or one or more cameras (e.g., monocular, stereoscopic, RGB, infrared, etc.). As described above, based on this information, lane markings are identified, and changes to the lane structure of a roadway are identified.

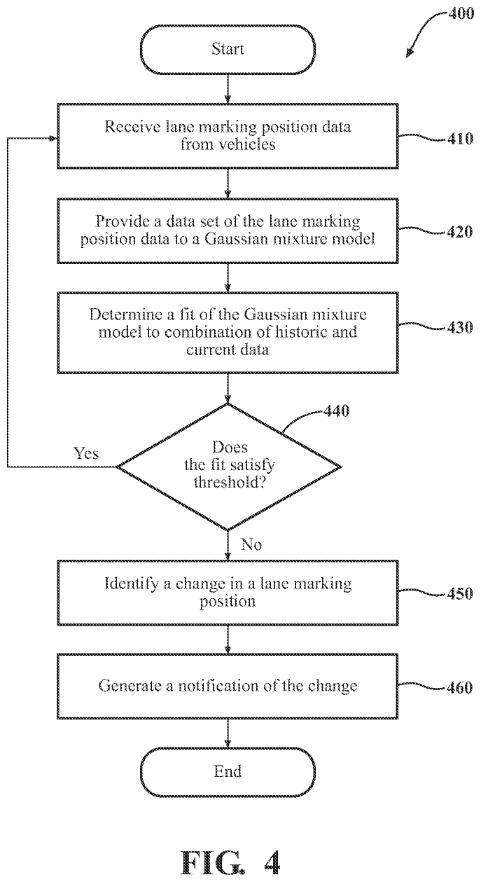

Additional aspects of improving the accuracy of road map data will be discussed in relation to FIG. 4. FIG. 4 illustrates a flowchart of a method 400 that is associated with detecting changes by applying a GMM 216 to vehicle-captured indicia of lane marking positions. Method 400 will be discussed from the perspective of the lane marking change detection system 210 of FIG. 2. While method 400 is discussed in combination with the lane marking change detection system 210, it should be appreciated that the method 400 is not limited to being implemented within the lane marking change detection system 210 but is instead one example of a system that may implement the method 400.

As described above, the detection of a change to the lane structure of a road is based on lane marking position data captured by various vehicles 100 that travel the road. As such, at 410, the lane marking change detection system 210 receives lane marking position data from the vehicles 100. As part of receiving the lane marking position data, it is generally understood that the sensors of the sensor systems 330 acquire the sensor data 214 of a region around the ego vehicle 100 with data acquired from different types of sensors generally overlapping in order to provide for a comprehensive sampling of the surrounding environment at each time step. In general, the sensor data 214 need not be of the exact same bounded region in the surrounding environment but should include a sufficient area of overlap such that distinct aspects of the area can be correlated. Thus, the sensor system 330 controls the sensors to acquire the sensor data 214 of the surrounding environment.

The acquired lane marking position data may take a variety of forms. For example, the lane marking position data may be lateral offset measurements from the center of the roadway. In an example, the lane marking change detection system 210 may include a processor that, through image analysis or map analysis identifies a centerline of a roadway. For example, map data accessible to the lane marking change detection system 210 may define a roadway as a graph with a center of the roadway marked as an edge with known geographic coordinates. Using the vehicle 100 sensor output (e.g., GPS coordinate and odometry), the lane marking change detection system 210 snaps the vehicle 100 to the centerline edge. The processor of the vehicle 100 or of the lane marking change detection system 210 may perform image/sensor output analysis (e.g., pixel analysis of an image) to determine the position of the lane marking 102 relative to the vehicle 100. Put another way, the processor of the vehicle 100 or the lane marking change detection system 210 may perform object detection and distance measurement to identify the position of the lane marking 102 relative to the vehicle 100 and/or center of the road. Snapping the vehicle 100 to the centerline in this fashion, and then evaluating the distance from the vehicle 100 to the detected object from the sensor output, facilitates measuring the lateral position of the lane markings as an offset from the centerline of the road.

In an example, the sign of the offset measurement may indicate a lateral side of the vehicle 100 where the lane marking 102 was detected. For example, negative measurements may indicate a lane marking 102 detected to the left of the vehicle 100, while positive measurements may indicate a lane marking 102 detected to the right of the vehicle. As described above, the lane marking change detection system 210 acquires this information from various vehicles 100 that have traversed a particular roadway such that 1) a GMM 216 may be generated for the historical data, which indicates a likely position for various lane markings 102 across a roadway and 2) to determine when the GMM 216 is no longer a fit to the data, which is an indication that the lane structure of the roadway has changed.

In general, the lane marking change detection system 210 retrieves the lane marking position data at successive iterations or time steps. Thus, the lane marking change detection system 210, in one embodiment, iteratively executes the functions discussed at blocks 410-440 to acquire the sensor data 214 and provide information therefrom. Furthermore, the lane marking change detection system 210, in one embodiment, executes one or more of the noted functions in parallel for separate observations in order to maintain updated perceptions. Additionally, as previously noted, the lane marking change detection system 210, when acquiring data from multiple sensors, fuses the data together to form the sensor data 214 and to provide for improved determinations of detection, location, and so on.

At 420, the lane marking change detection system 210 provides a data set of the lane marking position data to a GMM 216. As described above, the data set that is provided to the fit module 222 reflects currently collected lane marking position data that is to be compared against the historic lane marking position data such that lane marking changes may be detected. In an example, the currently collected data set reflects a batch of lane marking position data that is collected. That is, rather than sending individual instances of lane marking position data collected by a vehicle 100 in real-time, the lane marking change detection system 210 may intermittently send batches of collected data. That is, the fit module 222 may provide a data set of lane marking position data that indicates multiple days of collected lane marking position data. In this example, the batched data allows the lane marking change detection system 210 to efficiently determine that a lane change has occurred and identify when the lane change has occurred.

For example, the GMM 216 may have a first BIC metric, X, before a current collection period for the underlying historic lane marking position data. After the collection period (e.g., five days), the GMM 216 may have a second BIC metric, Y, for the combination of 1) the underlying historic lane marking position data and 2) the data set of currently collected lane marking position data. In this example, if Y is greater than a threshold value or is greater than X by a threshold value, the lane marking change detection system 210 may determine that there has been a change to the lane structure of the road and that such occurred within the last five days. By comparison, if Y is not greater than a threshold value or is not greater than X by a threshold value, the lane marking change detection system 210 may determine that there has not been a change to the lane structure in the last five days.

At 430, the fit module 222 determines whether the GMM 216 is a good fit for the sensor data 214, specifically with the data set of currently collected measurements included. That is, the fit module 222 includes instructions that cause the processor 218 to determine a fit of the GMM 216 to a combination of the historic lane marking position data and the data set. As described above, the “fit” or how well the model represents the underlying data may be used to determine whether or not there has been a change. If the fit is within a defined threshold, which may be set by an administrator, statistical best practices, or any other modality, then it may be determined that the GMM 216 satisfactorily defines the underlying data and that the resulting Gaussian curves accurately represent the number and position of lane markings 102. By comparison, if the fit quality is not within a threshold range, i.e., it is not a good fit, then it may be determined that the GMM 216 does not satisfactorily define the underlying data and the resulting Gaussian curves do not accurately represent the number and/or position of the lane markings 102.

Different fitness metrics may be used, including a BIC, which measures model fit. Generally, a lower BIC indicates a better fit, while a higher BIC indicates that the model does not fit the data as well. The BIC will go up when the underlying data changes and indicates a change to the position and/or number of lanes.

In an example, a BIC fitness metric may be used when the change to the fitness metric, rather than the fitness metric itself, triggers lane marking change detection. In some examples, the threshold BIC change that may indicate a lane marking change may be between 10% and 20%. That is, a 10-20% increase in the BIC of the GMM 216 following the addition of currently collected data may indicate a lane marking change, while an increase in the BIC that is less than this range may be attributed to natural variation. In another example, a difference in BIC between the pre-collection and post-collection period of 0-2 may indicate weak evidence of a lane marking change, while a BIC difference of between 2-6 indicates positive evidence of lane marking change, and a BIC difference of between 6-10 indicates strong evidence. As such, the threshold BIC change that may be relied on to indicate lane marking change may be a percentage or a numeric difference and may be selected based on any desired criteria.

Another example of a fitness metric is a Silhouette score, which measures the mean silhouette coefficients across all samples. For example, a Silhouette score may be used when the fitness metric itself triggers a lane marking change detection rather than any change to the fitness metric. In some examples, the Silhouette score ranges between 0 and 1, with a score below 0.6 indicating a lane marking change. As such, in an example, the threshold Silhouette score is 0.6, with Silhouette scores less than 0.6 indicating a likely change to the lane structure of the road. In an example, the Silhouette score may also be used when a change to the fitness metric is the trigger by which lane structure change is detected.

Other fitness metrics that may be implemented by the fit module 222 include a Wasserstein distance, which is the distance between consecutive means at steps of model fitting, and a Wasserstein weight, which is the Wasserstein distance between consecutive weights. While particular reference is made to particular fitness metrics, various fitness metrics may be relied on to test the fitness of the GMM 216 to the underlying historic lane marking position data.

At 440, it is determined if the fitness metric of the GMM 216 satisfies a threshold, which threshold delineates measurement differences that can be attributed to natural variation vs. those that indicate a change to the lane structure of a roadway. The threshold against which the fitness metric is compared may take various forms, such as a percentage reduction, a numerical value reduction, or an absolute value of the fitness metric.

In one example, the threshold is a measurement threshold. That is, the fit module 222 includes instructions that cause the processor 218 to identify a lane marking change based on the fit of the GMM 216 to the combination of the historic data and currently collected data being less than a threshold. That is, a certain fitness value may delineate naturally occurring measurement variations from lane-change-based measurement variations. For example, given a Silhouette score threshold of 0.6, if the addition of the data set to the original input (i.e., the historic lane marking position data) that is modeled by the GMM 216 causes the Silhouette score to fall below 0.6, the fit module 222 may indicate that the GMM 216 is no longer a good fit to the data, on account of the addition of the currently collected batch of data. By comparison, if the addition of the data set to the original input does not cause the Silhouette score to fall lower than 0.6, the fit module 222 may indicate that the GMM 216 remains a reliable indication of lane marking 102 position, and the method 400 returns to receiving and processing lane marking position data. In this example, the currently collected lane marking position data is added to the historic lane marking position data, which serves as the basis for comparison with subsequently captured data.

In another example, the threshold is a change threshold. That is, the fit module 222 includes instructions that cause the processor 218 to 1) determine a fit of the GMM 216 to the historic lane marking position data (without the data set of currently collected measurements), 2) determine a fit of the GMM 216 to the combination of the historic lane marking position data and the data set of currently collected measurements, and 3) identify the change based on a difference between the fit of the GMM 216 to the combination and the fit of the GMM to just the historic lane marking position data being greater than a threshold amount.

In this example, the change in fitness, rather than the absolute fitness value, indicates a lane-change-based measurement variation. For example, a first BIC may have a value of X, which first BIC indicates the fit of the GMM 216 to just the historic lane marking position data. A second BIC may have a value of Y, which second BIC indicates the fit of the GMM 216 to the combination of the historical data and the currently collected data. If Y is greater than X by some threshold value Z (e.g., 10-20%, 2-6 points, or 6-10 points), the fit module 222 may indicate that the GMM 216 is no longer a good fit to the data, on account of the addition of the currently collected batch of data. By comparison, if Y is not greater than X by the threshold value Z, the fit module 222 may indicate that the GMM 216 remains a reliable indication of lane marking 102 positions, and the method 400 may return to receiving and processing lane marking position data. In this example, the currently collected lane marking position data is added to the historic lane marking position data, which serves as the basis for comparison with subsequently captured data.

In either case, if the fit module 222 determines that the fit does not satisfy an associated threshold, at 450, the change module 224 identifies a change in the position of a lane marking 102 on a roadway. That is, the change module 224 includes instructions that cause the processor 218 to identify a change in a lane marking 102 on the roadway based on the fit of the GMM 216 to the combination of historic and current data.

The identification may take a variety of forms. For example, the identification may indicate that a change has occurred. In another example, the identification may indicate additional detail regarding the change, for example, whether it is a change in the position of lane markings 102, a change to the number of lane markings 102, or a combination of both. FIGS. 5-7 depict examples of different lane marking changes and indicia of such changes as evidenced by the Gaussian distribution/curves.

In an example, the change module 224 includes instructions that cause the processor 218 to analyze metadata associated with the currently collected data set and the historic lane marking position data to determine a change to a type of the lane marking 102. That is, there are various types of lane markings, such as lane markings of different colors (e.g., yellow and white), solid lane markings, dashed lane markings, double-solid lane markings, and solid lane/dashed markings. In these examples, metadata associated with the captured sensor data 214 may indicate the type of lane marking 102 detected. As such, each instance of collected data may be tagged with a type of lane marking 102. In addition to analyzing the GMM 216 and resulting Gaussian curves 106, the lane marking change detection system 210 can analyze the tags associated with particular lane marking position data to identify differences therein. For example, metadata associated with historic lane marking position data associated with a first lane marking 102 may indicate that the associated lane marking 102 is a dashed type marking. Metadata associated with the currently collected data for this lane marking 102 may indicate that the type of lane is a solid type lane marking. As such, in this example, regardless of the change indicated by a GMM fitness metric, the lane marking change detection system 210 may identify and generate a notification for a lane marking change, this change being of the type of lane marking.

At 460, the change module 224 generates a notification of the change. That is, the change module 224 includes instructions that cause the processor 218 to generate a notification of the change in the lane marking 102. In an example, the notification is provided to a map manager, such as a third-party entity that curates maps and updates the maps in the face of changes to a road structure. Responsive to the generated notification, the map manager may take various remedial actions, such as investigating the road structure to identify the lane change and updating the map to reflect the changed road structure.

As such, the present method 400 relies on lane marking position data, both historically and currently collected to identify and notify changes to the lane structure of a roadway such that map data is continuously updated to reflect the actual lane marking structure of a road, rather than becoming outdated as changes to the lane structure occur.

As described above, in addition to detecting that a change to the lane marking 102 has occurred, the lane marking change detection system 210 may determine a type of change that has occurred. Specifically, the change module 224 includes instructions to identify a type of the change in the lane marking 102 on the roadway based on a shape change of Gaussian curves 106 that are generated by the GMM 216 responsive to provision of the data set as input to the GMM 216. As particular examples, the change module 224 may include instructions that cause the processor 218 to 1) identify a change in the number of lanes on the roadway based on the shape change of the Gaussian curves 106 and/or 2) identify a shift in the position of the lanes on the roadway based on the shape change of the Gaussian curves 106.

FIG. 5 illustrates the detection of a lane shift from lane marking position data. As described above, the change module 224 may analyze the Gaussian curves 106 and, more specifically, changes to the Gaussian curves 106 that result from the addition of currently-collected lane marking position data. These changes may indicate the type of change made to the lane structure of the road. Note that the changes to the Gaussian curves 106 depicted in the figures may be based on the lane lateral position measurements of multiple vehicles, which measurements may be similar to those lateral position 108 measurements indicated in FIG. 5.

For example, the vehicle(s) 100 may detect a first lane marking 102-1 as having an updated lateral position 108-5 that differs from the original lateral position 108-1 as depicted in FIG. 1. The data indicating the shifting of the first lane marking 102-1 outward, or batched data indicating the shifting of the first lane marking 102-1 outward, may generate an updated first Gaussian curve 106-5, that is wider than the original first Gaussian curve 106-1. Similar shifts of updated lateral positions 108-6, 108-7, and 108-8 of the second lane marking 102-2, third lane marking 102-3, and fourth lane marking 102-4, respectively, may similarly result in updated second, third, and fourth Gaussian curves 106-6, 106-7, and 106-8 that are each wider than their original counterparts. In other words, a shifting of lane markings 102 may result in wider Gaussian curves 106 than their original counterparts, which widening may be detected by the change module 224 and serve as the basis for a generated notification. In this example, a comparison of fitness before and after the provision of the currently collected data to the GMM 216 determines whether a change has occurred, and an analysis of the Gaussian distribution and curves determines the type of change that occurred.

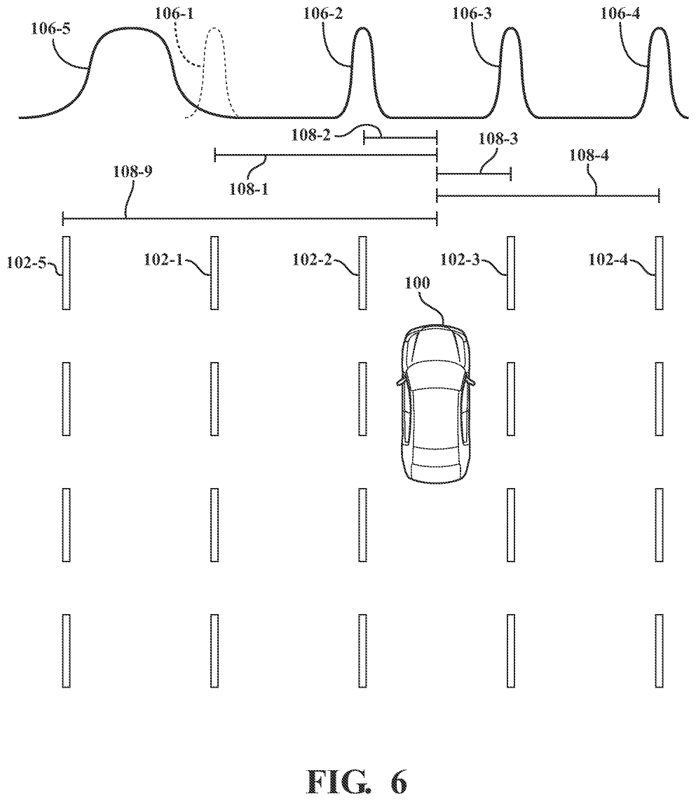

FIG. 6 illustrates the detection of an added lane from lane marking position data. Note that the changes to the Gaussian curves 106 depicted in the figures may be based on the lane lateral position measurements of multiple vehicles, which measurements may be similar to those lateral position 108 measurements indicated in FIG. 6.

In the example depicted in FIG. 6, a new lane has been added as defined by the first lane marking 102-1 and a new fifth lane marking 102-5. In this example, the fifth lane marking 102-5 may be identified as having a lateral position 108-9 of −22.5 feet, indicating that the fifth lane marking 102-5 is twenty-two and a half feet to the left of the center of the road. In this example, the updated first Gaussian curve 106-5 may be widened to include the fifth lane marking lateral position 108-9 measurement. Given that the other lane markings 102-1, 102-2, 102-3, and 102-4 have not changed position from the environment depicted in FIG. 1, the associated lateral positions 108-1, 108-2, 108-3, and 108-4 and Gaussian curves 106-2, 106-3, and 106-4 also do not change. As such, in this example, the GMM 216 attempts to fit data indicative of four lanes to a model representing three lanes. In this scenario, one of the distributions/curves (e.g., the updated first Gaussian curve 106-5) will be wider than the remaining curves. As such, in this example, the change module 224 may compare the parameters of the Gaussian distribution/curves (i.e., mean and variance values) to one another to determine the type of change, where one distribution is wider than the others by some threshold amount indicates a lane has been added.

FIG. 7 illustrates the detection of a removed lane from lane marking position data. Note that the changes to the Gaussian curves 106 depicted in the figures may be based on the lane lateral position measurements of multiple vehicles, which measurements may be similar to those lateral position 108 measurements indicated in FIG. 7.

In the example depicted in FIG. 7, a lane has been removed such that there is no longer a first lane marking 102-1. The updated first Gaussian curve 106-5 may be narrower in this example. Over time, as additional lane marking position measurements are added, the second Gaussian curve 106-2, third Gaussian curve 106-3, and fourth Gaussian curve 106-4 may naturally increase in width. The updated first Gaussian curve 106-5 by comparison may narrow relative to the other curves. As such, in this example, the GMM 216 is used to fit data indicative of two lanes to a model that represents three lanes. In this scenario, one of the distributions/curves (e.g., the updated first Gaussian curve 106-5) will be narrower than the remaining curves. As such, in this example, the change module 224 may compare the parameters of the Gaussian distribution/curves (i.e., mean and variance values) to one another to determine the type of change, where one distribution being narrower than the others by some threshold amount indicates a lane has been removed.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
provide a data set of lane marking positions collected from vehicles traversing a roadway as input to a Gaussian mixture model (GMM) that represents historic lane marking position data;
determine a fit of the GMM to a combination of the historic lane marking position data and the data set;
identify a change in a lane marking on the roadway based on the fit of the GMM to the combination; and
generate a notification of the change in the lane marking.

2. The system of claim 1, wherein:
the machine-readable instructions further comprise a machine-readable instruction that, when executed by the processor, causes the processor to determine a fit of the GMM to the historic lane marking position data; and
the machine-readable instruction that, when executed by the processor, causes the processor to identify the change in the lane marking on the roadway comprises a machine-readable instruction that, when executed by the processor, causes the processor to identify the change based on a difference between the fit of the GMM to the combination and the fit of the GMM to the historic lane marking position data being greater than a threshold amount.

3. The system of claim 1, wherein the machine-readable instruction that, when executed by the processor, causes the processor to identify the change in the lane marking on the roadway comprises a machine-readable instruction that, when executed by the processor, causes the processor to identify the change based on the fit of the GMM to the combination being less than a threshold amount.

4. The system of claim 1, wherein the machine-readable instructions further comprise a machine-readable instruction that, when executed by the processor, causes the processor to identify a type of the change in the lane marking on the roadway based on a shape change of Gaussian curves that define the GMM responsive to provision of the data set as input to the GMM.

5. The system of claim 4, wherein the machine-readable instruction that, when executed by the processor, causes the processor to identify the type of the change in the lane marking on the roadway comprises at least one of:
a machine-readable instruction that, when executed by the processor, causes the processor to identify a change in a number of lanes on the roadway based on the shape change of the Gaussian curves; or
a machine-readable instruction that, when executed by the processor, causes the processor to identify a shift in lanes on the roadway based on the shape change of the Gaussian curves.

6. The system of claim 1, wherein the machine-readable instructions further comprise a machine-readable instruction that, when executed by the processor, causes the processor to analyze metadata associated with the data set and the historic lane marking position data to determine a change to a type of the lane marking.

7. The system of claim 1, wherein the machine-readable instruction that, when executed by the processor, causes the processor to provide the data set of lane marking positions as input to the GMM comprises a machine-readable instruction that, when executed by the processor, causes the processor to provide a data set indicating multiple days of collected lane marking position data.

8. The system of claim 1, wherein the machine-readable instruction that, when executed by the processor, causes the processor to provide the data set of lane marking positions as input to the GMM comprises a machine-readable instruction that, when executed by the processor, causes the processor to provide the lane marking positions as offset measurements from a center of the roadway.

9. A non-transitory machine-readable medium comprising instructions that, when executed by a processor, cause the processor to:
provide a data set of lane marking positions collected from vehicles traversing a roadway as input to a Gaussian mixture model (GMM) that represents historic lane marking position data;
determine a fit of the GMM to a combination of the historic lane marking position data and the data set;
identify a change in a lane marking on the roadway based on the fit of the GMM to the combination; and
generate a notification of the change in the lane marking.

10. The non-transitory machine-readable medium of claim 9, wherein:
the machine-readable medium further comprises an instruction that, when executed by the processor, causes the processor to determine a fit of the GMM to the historic lane marking position data; and
the instruction that, when executed by the processor, causes the processor to identify the change in the lane marking on the roadway comprises an instruction that, when executed by the processor, causes the processor to identify the change based on a difference between the fit of the GMM to the combination and the fit of the GMM to the historic lane marking position data being greater than a threshold amount.

11. The non-transitory machine-readable medium of claim 9, wherein the machine-readable medium further comprises an instruction that, when executed by the processor, causes the processor to identify a type of the change in the lane marking on the roadway based on a shape change of Gaussian curves that define the GMM responsive to provision of the data set as input to the GMM.

12. The non-transitory machine-readable medium of claim 11, wherein the instruction that, when executed by the processor, causes the processor to identify the type of the change in the lane marking on the roadway comprises at least one of:
an instruction that, when executed by the processor, causes the processor to identify a change in a number of lanes on the roadway based on the shape change of the Gaussian curves; or
an instruction that, when executed by the processor, causes the processor to identify a shift in lanes on the roadway based on the shape change of the Gaussian curves.

13. The non-transitory machine-readable medium of claim 9, wherein the machine-readable medium further comprises an instruction that, when executed by the processor, causes the processor to analyze metadata associated with the data set and the historic lane marking position data to determine a change to a type of the lane marking.

14. The non-transitory machine-readable medium of claim 9, wherein the instruction that, when executed by the processor, causes the processor to provide the data set of lane marking positions as input to the GMM comprises an instruction that, when executed by the processor, causes the processor to provide a data set indicating multiple days of collected lane marking position data.

15. A method, comprising:
providing a data set of lane marking positions collected from vehicles traversing a roadway as input to a Gaussian mixture model (GMM) that represents historic lane marking position data;
determining a fit of the GMM to a combination of the historic lane marking position data and the data set;
identifying a change in a lane marking on the roadway based on the fit of the GMM to the combination; and
generating a notification of the change in the lane marking.

16. The method of claim 15, wherein:
the method further comprises determining a fit of the GMM to the historic lane marking position data; and
identifying the change in the lane marking on the roadway comprises identifying the change based on a difference between the fit of the GMM to the combination and the fit of the GMM to the historic lane marking position data being greater than a threshold amount.

17. The method of claim 15, further comprising identifying a type of the change in the lane marking on the roadway based on a shape change of Gaussian curves that define the GMM responsive to provision of the data set as input to the GMM.

18. The method of claim 17, wherein identifying the type of the change in the lane marking on the roadway comprises at least one of:
identifying a change in a number of lanes on the roadway based on the shape change of the Gaussian curves; or
identifying a shift in lanes on the roadway based on the shape change of the Gaussian curves.

19. The method of claim 15, further comprising analyzing metadata associated with the data set and the historic lane marking position data to determine a change to a type of the lane marking.

20. The method of claim 15, wherein providing the data set of lane marking positions as input to the Gaussian mixture model comprises providing a data set indicating multiple days of collected lane marking position data.
